(19) United States
(12) Patent Application Publication
(10) Pub. No.: US 2026/0336244 A1
(43) Pub. Date: Oct. 29, 2026

(54) SPAR CAP AND METHOD OF PRODUCTION THEREOF

(71) Applicant: Arkema France, Puteaux-La Defense (FR)

(72) Inventors: Alexander ZOLLER, LACQ (FR); Audrey LE FICHANT, SAINT AVOLD CEDEX (FR); Pierre GERARD, LACQ (FR); Pierre ESCALE, LACQ (FR)

(73) Assignee: Arkema France, Puteaux-La Defense (FR)

(21) Appl. No.: 19/110,831

(22) PCT Filed: Oct. 5, 2023
(86) PCT No.: PCT/EP2023/077656

§ 371 Date: Mar. 12, 2025

(30) Foreign Application Priority Data
Oct. 5, 2022 (FR) FR2210215

(51) Int. Cl. B29D 99/00; B29K 33/00; B29K 307/04; B29K 309/08; F03D 1/06

(52) U.S. Cl. CPC B29D 99/0028; F03D 1/0681; B29K 2033/08; B29K 2307/04; B29K 2309/08; F05B 2230/232

(57) ABSTRACT

The invention relates to a method for producing a spar cap for a rotor blade of a wind turbine. The method includes the steps of providing a plurality of pultruded planks that are a thermoplastic composite comprising 45% or less in volume of a polymeric matrix including (meth)acrylic polymers, and at least 55% in volume of fibers, preferably carbon fibers; stacking the pultruded planks into a pre-spar cap shape; and joining the staked pultruded planks in order to produce the spar cap. The invention also relates to a spar car, a rotor blade a method for producing a rotor blade and a wind turbine.

### FIELD OF THE INVENTION

The invention relates to the field of wind turbines, particularly blades of wind turbines and more particularly to spar caps manufactured from thermoplastic polymer composite. The invention relates to a method for producing a spar cap, a spar cap, a rotor blade comprising a spar cap and a method for producing a rotor blade comprising a spar cap.

### DESCRIPTION OF RELATED ART

At present, wind turbine blades are made from composite materials that are both light and resistant. Indeed, wind turbine blades are subject to bending, torsion or tensile stresses. This is mainly due to the fact that the blades of the wind turbine must support important mechanical loads during the operation of the wind turbine, especially in the presence of strong gusts of wind.

In order to consolidate their structure, spar caps have been integrated into the wind turbine blades. The spar cap may notably transfer the main aerodynamic bending loads from the rotor blades to the hub. A spar cap is incorporated into the blade and typically extends over a large portion of the total length of the blade.

These spar caps are usually designed with glass- and/or carbon fiber reinforced plastic (CFRP). With the development in the wind industry, CFRPs have given way to pultruded unidirectional fibrous composites having unidirectional fiber reinforcement.

In particular, the spar cap may comprise layers of unidirectional fiber infused into thermoset polymer resins to form a pre-spar cap. The pre-spar-cap is then positioned in a mold with the other components of the wind turbine blade to form a blade comprising the spar cap. For example, the spar cap can be manufactured by Vacuum Infusion Process (VIP) and in particular by Vacuum Assisted Resin Infusion (VARI). In this technique, the resin is applied once a complete vacuum is achieved. The liquid resin is then infused inside the mold.

In other embodiments, the spar cap can also be manufactured by Resin Transfer Molding (RTM) and for example by vacuum-assisted resin transfer molding (VARTM). RTM uses a closed mold with a layup of fibers placed into the mold. The mold is closed, sealed, heated. Heated resin is injected into the mold to impregnate the fiber layup. The mold is then held at a temperature sufficient to cure the resin, usually an epoxy resin. Current RTM technology produces lightweight parts with excellent mechanical properties. With these qualities, composite materials are gaining wide use in a variety of structural and non-structural applications common in aerospace and aviation.

VARTM differs from RTM in that fiber reinforcements and materials are laid up on a mold and vacuum bagged. The liquid resin is introduced through ports in the mold and vacuum-drawn through the reinforcements by way of designed-in channels and infusion media that facilitate fiber wet out. Subsequent curing does not require high heat or high pressure.

However, these techniques result in difficult and inhomogeneous impregnation leading to imperfections. These defects can extend over large areas and can significantly reduce the reliability of the final product. In addition, their repair is particularly time consuming and expensive.

Thus, techniques to improve the manufacture of spar cap have been developed.

For example, EP3569394 proposes a spar cap made by stacking and comprising layers of adhesive film between the layers of carbon fibers. These different layers are assembled together by different techniques such as pressure, heat, vacuum in a mold. The spar cap is then incorporated into the blade of the wind turbine. These spar caps comprise carbon fibers impregnated with epoxy resin.

Another solution disclosed in document WO2010/083840 proposes the incorporation of layer of uncured resin pre-impregnated fibers with layer of cured fiber reinforced resin, the cured layers having a greater rigidity than the uncured layers and thus increasing the rigidity of the spar cap. These layers include carbon, glass or aramid fibers and an epoxy, polyester, vinyl ester or phenol resin

Document EP3501810 proposes a spar cap made from a pultruded composite layer comprising abutment surface to facilitate the flow of the resin, and thus a better infusion of resin between the strips than with conventionally known strips. Nevertheless, the composite material is also made from glass or carbon fiber and a thermoset polymer such as an epoxy, vinyl ester, polyurethane, or polyester type resin.

Currently, spar caps are mainly composed of polymer composites in which a fibrous reinforcement is incorporated into a thermoset polymer matrix. The fibers of the fibrous reinforcement can typically be composed of glass, carbon or ceramic fibers, but also natural fibers. The polymer matrix, which is mainly composed of polymers, holds the fibers together, transmits the tensions between the fibers and protects the fibers from external mechanical and chemical influences. The polymer matrix is usually thermosetting and the thermosetting polymer composite parts are joined together with thermosetting resin (e.g. epoxy or polyester or polyurethane adhesives).

However, thermosetting composite materials have several disadvantages, such as high costs when recycling these materials or the accumulation of large amounts of waste if recycling is not possible. In addition, when constructing a wind turbine blade from polymer composites, for example by low pressure injection or infusion molding, the use of thermoset resins generally leads to long cycle times. In addition, these polymer composite parts are then assembled during the industrial process before delivery to the installation site. Given the long cycle times observed when using a thermoset polymer matrix, both during part manufacturing and assembly, thus, there is a need to identify polymers and/or resin that would be able to reduce cycle times and therefore reduce wind turbine production time.

In addition, for better cohesion, the production of spar caps can include the use of peel-plies which expensive and slows down production.

Moreover, it is very difficult to remove peel-ply on large surfaces, for example for turbine blades that can be around 100 meters long. This constitutes a real industrial challenge in terms of technical difficulty and time. Furthermore, the presence of a peel-ply increases the number of step and consequently time and cost during recycling, and in particular for removing the peel-ply.

Wind turbine blades incorporating thermoplastic materials have been proposed for example in application WO2010025830; however, the thermoplastics proposed are essentially proposed for forming the join between various parts of wind turbine blades, and they have a relatively high sensitivity to moisture or high melting points.

Application US2017/0058864 describes an adjustable wind turbine blade constructed from thermosetting and/or thermoplastic materials. The thermoset-thermoplastic interface is welded; nevertheless, the blade contains a large portion of the thermosetting materials.

The document EP2497945 discloses at least one spar-cap on each side of the blade and therefore within each half-blade. Each part is glued together such as to obtain a structure of the glued laminate type forming the spar cap. However, gluing two parts together introduces a risk of failure and defects. Also, the mechanical properties are not optimal. Furthermore, the bonding resins have epoxy type resins which do not allow easy recycling of the spar cap.

In document WO2018172656, the applicant has proposed the manufacture of wind turbine blades from a thermoplastic polymer composite having mechanical properties suitable for the wind power sector while being mainly recyclable. Such a wind turbine blade may comprise a reinforcing element comprising a thermoplastic polymer composite but also a low-density structure disposing in a sandwich-type structure. However, such wind turbine blades may comprise thermoset and may be connected by epoxy, or polyester, or polyurethane adhesive.

The document US2020/095978 discloses a joint interface for wind turbine rotor blade components. One component being a pair of longitudinally extending spar caps, which might have in-between disposed shear webs.

The document US2017/082089 concerns a wind turbine motor blade components formed from pultruded hybrid resin fiber reinforced composites. The document discloses pultruded plates having different portions formed with thermoset resin material and thermoplastic material respectively.

The document US2017/080648 concerns methods for manufacture for spar caps for wind turbine rotor blades using thermoplastic based composite plates. Each plate is pultruded and comprises a thermoplastic resin material.

Therefore, there is a need for spar caps comprising thermoplastics, and therefore easily recyclable, while offering mechanical and chemical properties that meet the requirements of the wind industry and reduce cycle times and cost to meet industrial issues.

### SUMMARY OF THE INVENTION

The following sets forth a simplified summary of selected aspects, embodiments and examples of the present invention for the purpose of providing a basic understanding of the invention. However, the summary does not constitute an extensive overview of all the aspects, embodiments and examples of the invention. The sole purpose of the summary is to present selected aspects, embodiments and examples of the invention in a concise form as an introduction to the more detailed description of the aspects, embodiments and examples of the invention that follow the summary.

The invention aims to overcome the disadvantages of the prior art. In particular, the invention proposes a method for producing a spar cap for a rotor blade of a wind turbine, said method comprising the steps of:
Providing a plurality of pultruded planks, said pultruded planks being a thermoplastic composite comprising 45% or less in volume of a polymeric matrix including (meth)acrylic polymers, and at least 55% in volume of fibers, preferably carbon fibers;
Stacking the pultruded planks into a pre-spar cap shape; and
Joining the staked pultruded planks in order to produce the spar cap.

The advantage of this method is that spar caps comprise thermoplastics. The method according to the invention allows providing a recyclable solution for spar cap and preferably for pultruded spar cap and consequently of rotor blade of wind turbine. Each pultruded plank does not need to be glued to one another. In addition, a thermoplastic spar cap presents similar mechanical properties compared to thermoset resins.

In addition, the method according to the invention allows reducing waste and to facilitate the pultrusion process.

Furthermore, thanks to the thermoplastic content and to improve mechanical properties of the produced spar caps, it is possible to design pattern directly on the pultruded planks without using peel-ply for example.

The method according to the invention also allows to save time and to reduce cycle times.

According to other optional features of the method according to the invention, it can optionally include one or more of the following characteristics alone or in combination:
the step of providing a plurality of pultruded planks comprises a step of surface texturization preferably said textured surface has a Ra between 3 μm and 30 μm according to the norm ISO 4287:1997,
the pultruded planks have a thickness from 2 mm to 8 mm,
it further comprises a step for providing a plurality of interlayers,
the stacking step further comprises a thermoforming step,
the joining step is conducted in a scar cap mold.
the joining step is conducted in a rotor blade mold, and wherein the staked pultruded planks of the spar cap are joined at the time of the formation of the rotor blade, preferably through infusion and/or thermoplastic adhesive,
the step of providing a plurality of pultruded planks comprises the following steps:
   Providing roving fibers;
   Impregnating the fibers with a polymeric resin comprising a polymeric matrix including (meth)acrylic polymers;
   Heating the impregnated fibers;
   Cooling the heated composite with optional calendaring; and.
   Pull out the pultruded planks;
the polymeric matrix comprises at least one multifunctional (meth) acrylic monomer, said multifunctional (meth) acrylic monomer comprising at least two (meth) acrylic functions,
the pultruded planks do not comprise a peel-ply.

According to another aspect, the invention can also relate to a spar cap for wind turbine obtainable by a method according to the invention.

According to other optional features of the spar cap according to the invention, it can optionally include one or more of the following characteristics alone or in combination:
it comprises a plurality of pultruded planks, said pultruded planks being a thermoplastic composite comprising 45% or less in volume of a polymeric matrix including (meth)acrylic polymers, and at least 55% in volume of fibers, preferably carbon fibers, a plurality may correspond to at least two.
the pultruded planks have at least one textured surface said textured surface has a Ra between 3 μm and 30 μm according to the norm ISO 4287:1997.
the pultruded planks may be separated by one or more interlayers.

According to another aspect, the present invention can also relate to a rotor blade comprising a spar cap according to the invention.

According to another aspect of the present invention, it is provided a wind turbine comprising a spar cap according to the invention or a rotor blade according to the invention.

According to another aspect, the present invention can also relate to a method for producing a rotor blade comprising a spar cap according to the invention, said method comprising associating the spar cap with a shell and a shear web and joining them through gluing, welding and/or infusion.

### BRIEF DESCRIPTION OF DRAWINGS

The foregoing and other objects, features and advantages of the present invention will become more apparent from the following detailed description when taken in conjunction with the accompanying drawings in which:

FIG. 1 is a schematic view of a method according to an embodiment of the present invention.

FIG. 2 is a schematic view of a step of providing a plurality of pultruded planks according to an embodiment of the present invention.

FIG. 3 is a pultruded plank sample before (left) and after (right) embossing treatment by calendaring on the pultrusion line after the die.

Several aspects of the present invention are disclosed with reference to flow diagrams and/or block diagrams of methods and devices according to embodiments of the invention.

On the figures, the flow diagrams and/or block diagrams show the architecture, the functionality and possible implementation of devices or systems or methods, according to several embodiments of the invention.

For this purpose, each box in the flow diagrams or block diagrams may represent a system, a device, a module.

In some implementations, the functions associated with the box may appear in a different order than indicated in the drawings.

For example, two boxes successively shown, may be executed substantially simultaneously, or boxes may sometimes be executed in the reverse order, depending on the functionality involved.

Each box of flow diagrams or block diagrams and combinations of boxes in flow diagrams or block diagrams may be implemented by special systems that perform the specified functions or actions or perform combinations of special equipment.

### DETAILED DESCRIPTION

A description of example embodiments of the invention follows.

By “polymer” is meant either a copolymer or a homopolymer or a block copolymer. The term “copolymer” means a polymer grouping together several different monomer units and the term “homopolymer” means a polymer grouping identical monomer units. By “block copolymer” is meant a polymer comprising one or more uninterrupted blocks of each of the distinct polymer species, the polymer blocks being chemically different from each other and being linked together by a covalent bond. These polymer blocks are also called polymer blocks.

The expression “polymer composite”, within the meaning of the invention, denotes a multicomponent material comprising at least two immiscible components in which at least one component is a polymer, and the other component may for example be a fibrous reinforcement.

By “fibrous reinforcement” or “fibrous substrate” or “fibers” is meant, within the meaning of the invention, several fibers, unidirectional fibers or of braids, or a continuous filament mat, fabrics, felts, or nonwovens which may be under the form of bands, webs, braids, wicks or pieces.

The term “matrix” can refer to a material serving as a binder and capable of transferring forces to the fibrous reinforcement. The “polymer matrix” includes polymers but can also include other compounds or materials. Thus, the “(meth)acrylic polymer matrix” refers to all types of compounds, polymers, oligomers, copolymers or block copolymers, acrylics and methacrylics. However, it would not be departing from the scope of the invention if the (meth)acrylic polymer matrix comprises up to 10% by weight, preferably less than 5% by weight of other non-acrylic monomers, chosen for example from the group: butadiene, isoprene, styrene, substituted styrene such as α-methylstyrene or tert-butylstyrene, cyclosiloxanes, vinylnaphthalenes and vinyl pyridines.

The term “resin” in the meaning of the invention may refer to a liquid sirup serving as a binder which is capable of transferring forces to the fibers. The “resin” may include polymers but may also include other compounds as monomer, and/or oligomer. Preferably a resin according to the invention is polymerizable.

The term “initiator” within the meaning of the invention, can refer to a compound which can start 1 initiate/continue the polymerization of a monomer or of monomers.

The term “polymerization” within the meaning of the invention can refer to the process of converting a monomer or a mixture of monomers into a polymer.

The term “monomer”, within the meaning of the invention, can refer to a molecule which can undergo polymerization.

For the purposes of the invention, the term “thermoplastic polymer” can refer to a polymer which is generally solid at room temperature, which may be crystalline, semi-crystalline or amorphous, and which softens during an increase in temperature, in particular after passing its glass transition temperature (Tg) and flowing at a higher temperature and/or being able to observe a clear melting at the passage of its so-called melting temperature (Tf) (when it is semi-crystalline), and which becomes solid again when the temperature drops below its melting point and below its glass transition temperature. This also applies for thermoplastic polymers slightly crosslinked by the presence of multifunctional monomers or oligomers in the formulation of the “syrup” (meth) acrylate, in percentage by mass preferably less than 10%, preferably less than 5% and so preferred less than 2% and may be at least 0.5%, which can be thermoformed when heated above the softening temperature.

The term “thermoplastic composition” can refer to a thermoplastic syrup or thermoplastic resin or a thermoplastic resin precursor but also mixtures of a thermoplastic resin or a thermoplastic resin precursor respectively with monomers. The term “thermoplastic resin precursor” refers to a prepolymer, comprising already several polymerized monomers as monomer units in the prepolymer chain, said prepolymer of further is capable polymerization in order to achieve a higher molecular mass once fully polymerized or in other words can continue to polymerize.

The term “thermosetting polymer” can refer to a plastic material which irreversibly transforms by polymerization.

The term “(meth)acrylic monomer” can refer to any type of acrylic and methacrylic monomer.

The term “(meth)acrylic polymer” can refer to a polymer essentially comprising (meth)acrylic monomers which represent at least 50% by weight or more of the (meth)acrylic polymer.

The term “PMMA”, within the meaning of the invention, can refer to homopolymers and copolymers of methyl methacrylate (MMA), the weight ratio of MMA in the PMMA preferably being at least 70% by weight for the MMA copolymer.

The expression “reinforcing element” as used can refer to an element used within/with a structure in order to strengthen it, support it, solidify it, consolidate it, improve its mechanical properties (reinforcement, tension, stretching, etc.) its thermal, electrical and/or chemical properties.

The abbreviation “phr” can refer to parts by weight per hundred parts of composition. For example, 1 phr of initiator in the composition means that 1 kg of initiator is added to 100 kg of composition.

The abbreviation “ppm” can refer to parts by weight per million parts of composition. For example, 1000 ppm of a compound in the composition means that 0.1 kg of the compound is present in 100 kg of the composition.

The term “about” as used herein can allow for a degree of variability in a value or range, for example, within 10%, within 5%, or within 1% of a stated value or of a stated limit of a range.

The term “wind turbine blade” or “rotor blade” may be used interchangeably. A rotor blade within the meaning of the invention may correspond to an air foil rotating around an axis.

The term “wind turbine” can refer to all the elements corresponding to an entirely constituted wind turbine. A wind turbine as used herein can refer to a device that converts the kinetic energy of the wind into mechanical energy.

The term “recyclable” may refer to the resin which can be recycled at 90%, preferably at more than 90% and more preferably at more than or egal to 95%.

As mentioned, wind turbine blades are subject to mechanical and chemical stresses during their operation. In addition, wind turbine blades are not entirely recyclable, and their manufacturing time is long. The current methods propose composite materials mainly composed of thermosetting polymer to manufacture a spar cap which is then assembled with the wind turbine blade. In addition, in order to increase the properties of wind turbine blades and spar-caps, a texturing comprising peel-ply is introduced into the manufacture. However, peel-ply is difficult to recycle and time consuming.

The current production of spar cap presents different industrial techniques without allowing to favour recycling and to answer the constraints of the sector. In addition, these techniques and the recycling of current spar caps are too long for the industry and too expensive.

Consequently, there is a need for new spar caps and new spar cap manufacturing techniques that can be easily produced and recycled, while offering mechanical and chemical properties that meet the requirements of the wind energy sector and reduce production times and cost.

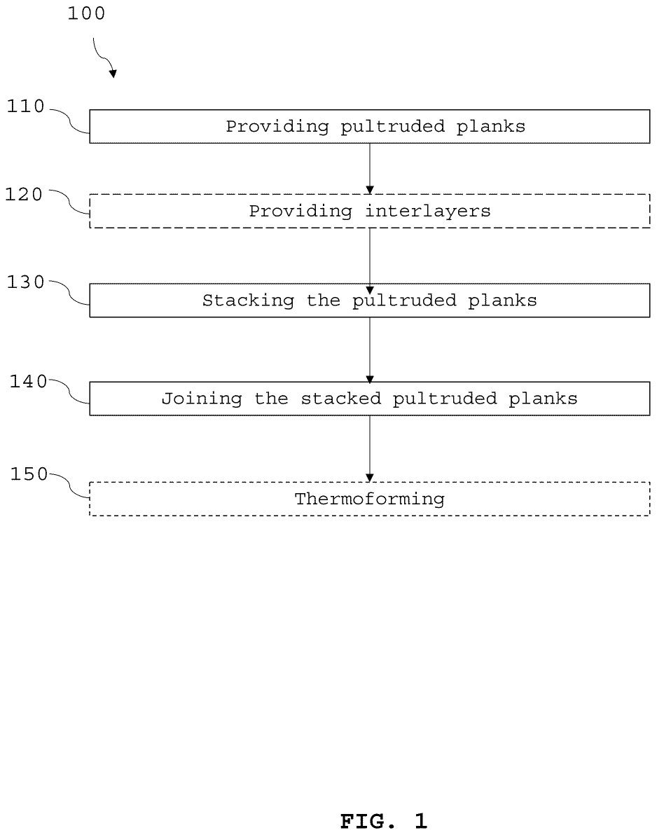

The present invention proposes according to a first aspect a method for producing a spar cap for a rotor blade of a wind turbine as illustrated for example in the FIG. 1.

A method 100 for producing a spar cap for a rotor blade of a wind turbine comprises providing a plurality of pultruded planks 110, stacking the pultruded planks 130 and joining 140 the stacked pultruded planks.

A method according to the invention can also comprise a surface texturization step 115, a step of providing 120 a plurality of interlayers, a thermoforming 160 step.

As shown in FIG. 1, a method 100 for producing a spar cap for a rotor blade of a wind turbine according to the invention comprises a step of providing 110 a plurality of pultruded planks. Preferably said pultruded planks are a thermoplastic composite comprising 45% or less in volume of a polymeric matrix including (meth)acrylic polymers, and at least 55% in volume of fibers, preferably carbon fibers. More preferably, the thermoplastic composite comprises 40% or less in volume of a polymeric matrix including (meth)acrylic polymers, and at least 60% in volume of fibers, and even more preferably the thermoplastic composite comprises 35% or less in volume of a polymeric matrix including (meth)acrylic polymers, and at least 65% in volume of fibers. The pultruded planks are a thermoplastic composite comprising at least 25% in volume of a polymeric matrix including (meth)acrylic polymers, and at most 75% in volume of fibers. Preferably the thermoplastic composite comprises at least 27% in volume of a polymeric matrix including (meth)acrylic polymers, and at most 73% in volume of fibers. More preferably, the thermoplastic composite comprises at least 30% in volume of a polymeric matrix including (meth)acrylic polymers, and at most 70% in volume of fibers. The pultruded planks are a thermoplastic composite comprising between 25% and 45% in volume of a polymeric matrix including (meth)acrylic polymers, and between 55% and 75% in volume of fibers. Preferably, the thermoplastic composite comprises between 27% and 40% in volume of a polymeric matrix including (meth)acrylic polymers, and between 60% and 73% in volume of fibers. More preferably, the thermoplastic composite comprises between 30% and 35% in volume of a polymeric matrix including (meth)acrylic polymers, and between 65% and 70% in volume of fibers.

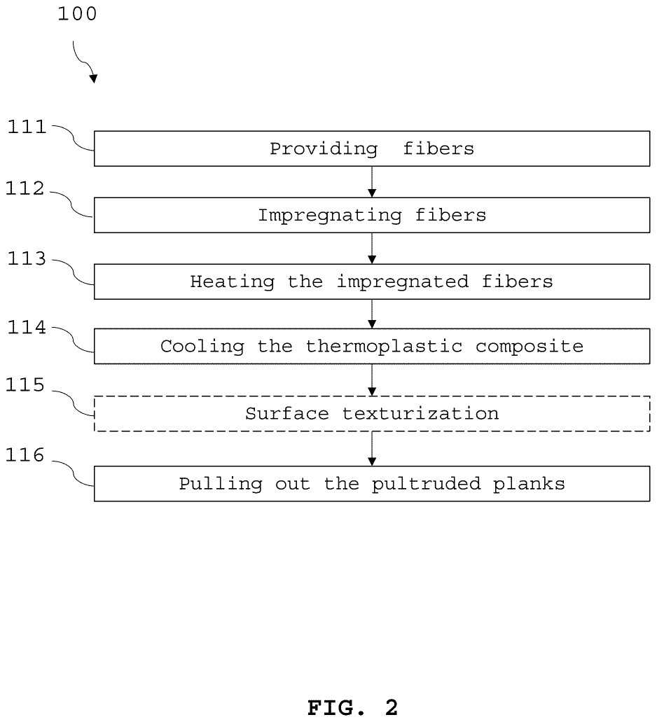

The step of providing 110 a plurality of pultruded planks may comprise as illustrated in the FIG. 2 the following steps: provide 111 roving fibers; impregnating 112 the fibers with a thermoplastic composition preferably a polymeric resin comprising a polymeric matrix including (meth)acrylic polymers; heating 113 the impregnated fibers; cooling 114 the heated composite with optional texturization 115 (i.e. surface texturization) preferably a calendaring; and pull out 116 the pultruded planks.

As shown in FIG. 2, the method according to the invention may comprise a step of providing 111 roving fibers. The step is preferably implemented by a fiber feeder device.

The step of providing 111 roving fibers allows providing fibers in a direction of a pultrusion path.

The fibers may be made of several fibers, unidirectional rovings or continuous filament mat, fabrics, felts or nonwovens that may be in the form of strips, laps, braids, locks or pieces. The fibrous material of the composite may have various forms and dimensions, either one-dimensional, two-dimensional or three-dimensional.

The one-dimensional form corresponds to linear long fibers. The fibers may be discontinuous or continuous. The fibers may be arranged randomly or parallel to each other, in the form of a continuous filament. A fiber is defined by its aspect ratio, which is the ratio between the length and diameter of the fiber. Preferably, the fibers used in the present invention are long fibers or continuous fibers. The fibers may have an aspect ratio of at least 1000, preferably at least 1500, more preferably at least 2000, advantageously at least 3000 and more advantageously at least 5000, even more advantageously at least 6000, more advantageously still at least 7500 and most advantageously at least 10 000.

The two-dimensional form corresponds to nonwoven or woven fibrous mats or reinforcements or bundles of fibers, which may also be braided. Even if the two-dimensional form has a certain thickness and consequently in principle a third dimension, it is considered as two-dimensional according to the present invention.

The three-dimensional form corresponds, for example, to nonwoven fibrous mats or reinforcements or stacked or folded bundles of fibers or mixtures thereof, an assembly of the two-dimensional form in the third dimension.

The origins of the fibrous material may be natural or synthetic. As natural material one can mention plant fibers, wood fibers, animal fibers or mineral fibers.

Natural fibers are, for example, sisal, jute, hemp, flax, cotton, coconut fibers, and banana fibers. Animal fibers are, for example, wool or hair.

As synthetic material, mention may be made of polymeric fibers chosen from fibers of thermosetting polymers, of thermoplastic polymers, of polyamide (aliphatic or aromatic), polyester, polyvinyl alcohol, polyolefins, polyurethanes, polyvinyl chloride, polyethylene, unsaturated polyesters, epoxy resins and vinyl esters, and/or carbon fibers or mixtures thereof.

The mineral fibers may also be chosen from glass fibers, especially of E, R or S2 type, boron fibers, basalt fibers or silica fibers.

The fibers of the present invention may be chosen from plant fibers, wood fibers, animal fibers, mineral fibers, synthetic polymeric fibers, glass fibers and carbon fibers, and mixtures thereof.

Preferably, the fibers are mineral fibers. More preferably the fibers are glass fibers or carbon fibers.

In a first more preferred embodiment, the fibers are glass fibers.

In a second more preferred embodiment the fibers are carbon fibers.

The fibers can have a diameter between 0.005 μm and 100 μm, preferably between 1 μm and 50 μm, more preferably between 5 μm and 30 μm and advantageously between 10 μm and 25 μm.

Preferably, the fibers of the present invention are chosen from continuous fibers (meaning that the aspect ratio does not necessarily apply as for long fibers) for the one-dimensional form, or for long or continuous fibers for the two-dimensional or three-dimensional form of the fibrous reinforcement.

The method according to the invention may comprise a step of wetting (i.e. impregnating) 112 fibers. The step is preferably implemented by an impregnation device. The step of wetting allows fibers to be impregnated with the thermoplastic composition, in other words, the penetration of the thermoplastic composition with the fibers. The step of wetting fibers may comprise the passage of fibers through a thermoplastic composition. For example, the fibers are guided through a bath or an injection chamber comprising the thermoplastic composition. The thermoplastic composition may be a polymeric resin and/or a polymeric resin precursor. The thermoplastic composition may comprise at least 50% in weight of monomers of the thermoplastic composite. The thermoplastic composition may comprise at most 90% in weight of monomers of the thermoplastic composite. The thermoplastic composition may comprise a polymeric resin comprising a polymeric matrix. The polymeric matrix may comprise a (meth)acrylic polymers. The thermoplastic composition may comprise a polymer and a monomer.

Preferably the monomer of the thermoplastic composite is selected from alkyl acrylic monomers, alkyl methacrylic monomers, hydroxyalkyl acrylic monomers and hydroxyalkyl methacrylic monomers, and mixtures thereof.

Preferably the polymer of the thermoplastic composite is selected from all types of compounds, polymers, oligomers, copolymers or block copolymers, acrylics and methacrylics. However, it would not be departing from the scope of the invention if the (meth) acrylic polymer matrix comprises up to 10% by weight, preferably less than 5% by weight of other non-acrylic monomers, chosen for example from the group: butadiene, isoprene, styrene, substituted styrene such as α-methylstyrene or tert-butylstyrene, cyclosiloxanes, vinylnaphthalenes and vinyl pyridines.

The thermoplastic composition according to the invention may comprise between 10 wt % and 50 wt % of a (meth) acrylic polymer (PI) and between 50 wt % and 90 wt % of a (meth) acrylic monomer (Ml). Preferably the thermoplastic composition comprises between 10 wt % and 40 wt % of a (meth) acrylic polymer (PI) and between 60 wt % and 90 wt % of a (meth) acrylic monomer (Ml); and more preferably between 10 wt % and 30 wt % of a (meth) acrylic polymer (PI) and between 70 wt % and 90 wt % of a (meth) acrylic monomer (Ml).

The dynamic viscosity of the thermoplastic composition is in a range from 10 mPa*s to 10000 mPa*s, preferably from 20 mPa*s to 7000 mPa*s and advantageously from 20 mPa*s to 5000 mPa*s and more advantageously from 20 mPa*s to 2000 mPa*s and even more advantageously between 20 mPa*s and 1000 mPa*s. The viscosity of the thermoplastic composition can be easily measured with a Rheometer or viscosimeter. The dynamic viscosity is measured at 25 °C. If the thermoplastic composition has a Newtonian behaviour, meaning no shear thinning, the dynamic viscosity is independent of the shearing in a rheometer or the speed of the mobile in a viscometer. If the thermoplastic composition has a non-Newtonian behaviour, meaning shear thinning, the dynamic viscosity is measured at a shear rate of 1 s⁻¹ at 25 °C.

As regards thermoplastic composition of the invention, it comprises a (meth) acrylic monomer (Ml) and a (meth) acrylic polymer (PI). Once polymerized the (meth) acrylic monomer (Ml) is transformed to a (meth) acrylic polymer (P2) comprising the monomeric units of (meth) acrylic monomer (Ml) and other possible monomers (M2).

Preferably dynamic viscosity of the (meth) acrylic composition MCI is also in a range from 10 mPa*s to 10000 mPa*s, preferably from 20 mPa*s to 7000 mPa*s and advantageously from 20 mPa*s to 5000 mPa*s and more advantageously from 20 mPa*s to 2000 mPa*s and even more advantageously between 20 mPa*s and 1000 mPa*s.

As regards the (meth) acrylic polymer (PI), mention may be made of polyalkyl methacrylates or polyalkyl acrylates. According to a preferred embodiment, the (meth) acrylic polymer (PI) is polymethyl methacrylate (PMMA).

According to one embodiment, the methyl methacrylate (MMA) homo- or copolymer comprises at least 70%, preferably at least 80%, advantageously at least 90% and more advantageously at least 95% by weight of methyl methacrylate.

According to another embodiment, the PMMA is a mixture of at least one homopolymer and at least one copolymer of MMA, or a mixture of at least two homopolymers or two copolymers of MMA with a different average molecular weight, or a mixture of at least two copolymers of MMA with a different monomer composition.

The copolymer of methyl methacrylate (MMA) comprises from 70% to 99.9% by weight of methyl methacrylate and from 0.1% to 30% containing at least one by weight of at least one monomer ethylenic unsaturation that can copolymerize with methyl methacrylate.

These monomers are well known, and mention may be made especially of acrylic and methacrylic acids and alkyl (meth) acrylates in which the alkyl group contains from 1 to 12 carbon atoms. As examples, mention may be made of methyl acrylate and ethyl, butyl or 2-ethylhexyl (meth)acrylate. Preferably, the comonomer is an alkyl acrylate in which the alkyl group contains from 1 to 4 carbon atoms.

According to a first preferred embodiment, the copolymer of methyl methacrylate (MMA) comprises from 80% to 99.9%, advantageously from 90% to 99.9% and more advantageously from 90% to 99.9% by weight of methyl methacrylate and from 0.1% to 20%, advantageously from 0.1% to 10% and more advantageously from 0.1% to 10% by weight of at least one monomer containing at least one ethylenic unsaturation that can copolymerize with methyl methacrylate. Preferably, the comonomer is chosen from methyl acrylate and ethyl acrylate, and mixtures thereof.

The weight-average molecular mass of the (meth) acrylic polymer (PI) should be high, which means greater than 50 000 g/mol and preferably greater than 100 000 g/mol.

The weight-average molecular mass can be measured by size exclusion chromatography (SEC).

The (meth) acrylic polymer (PI) is fully soluble in the (meth) acrylic monomer (Ml) or in the mixture of (meth) acrylic monomers. It enables the viscosity of the (meth) acrylic monomer (Ml) or the mixture of (meth) acrylic monomers to be increased. The solution obtained is a liquid composition generally called a “syrup” or “prepolymer”. The dynamic viscosity value of the liquid (meth) acrylic syrup is between 10 mPa·s and 10 000 mPa·s. The viscosity of the syrup can be readily measured with a rheometer or a viscometer. The dynamic viscosity is measured at 25 °C.

Advantageously, the liquid (meth) acrylic composition or syrup contains no additional voluntarily added solvent.

As regards the (meth) acrylic monomer (Ml), the monomer is chosen from alkyl acrylic monomers, alkyl methacrylic monomers, hydroxyalkyl acrylic monomers and hydroxyalkyl methacrylic monomers, and mixtures thereof.

Preferably, the (meth) acrylic monomer (Ml) is chosen from hydroxyalkyl acrylic monomers, hydroxyalkyl methacrylic monomers, alkyl acrylic monomers, alkyl methacrylic monomers and mixtures thereof, the alkyl group containing from 1 to 22 linear, branched or cyclic carbons; the alkyl group preferably containing from 1 to 12 linear, branched or cyclic carbons.

More preferably, the (meth) acrylic monomer (Ml) is chosen from alkyl acrylic monomers or alkyl methacrylic monomers and mixtures thereof, the alkyl group containing from 1 to 22 linear, branched or cyclic carbons; the alkyl group preferably containing from 1 to 12 linear, branched or cyclic carbons.

Advantageously, the (meth) acrylic monomer (Ml) is chosen from methyl methacrylate, ethyl methacrylate, methyl acrylate, ethyl acrylate, methacrylic acid, acrylic acid, n-butyl acrylate, isobutyl acrylate, n-butyl methacrylate, isobutyl methacrylate, cyclohexyl acrylate, cyclohexyl methacrylate, isobornyl acrylate, isobornyl methacrylate, hydroxyethyl acrylate and hydroxyethyl methacrylate, and mixtures thereof.

More advantageously, the (meth) acrylic monomer (Ml) is chosen from methyl methacrylate, ethyl methacrylate, methyl acrylate, ethyl acrylate, methacrylic acid, acrylic acid, n-butyl n-butyl acrylate, isobutyl acrylate, methacrylate, isobutyl methacrylate, cyclohexyl acrylate, cyclohexyl methacrylate, isobornyl acrylate, isobornyl methacrylate, and mixtures thereof.

According to a preferred embodiment, at least 50% by weight and preferably at least 60% by weight of the (meth) acrylic monomer (Ml) is methyl methacrylate.

According to a first more preferred embodiment, at least 50% by weight, preferably at least 60% by weight, more preferably at least 70% by weight, advantageously at least 80% by weight and even more advantageously 90% by weight of the monomer (Ml) is a mixture of methyl methacrylate with optionally at least one other monomer. For example, the at least one other monomer can be a multifunctional (meth) acrylic monomer (M2).

As regards the (meth) acrylic monomer (M2), the monomer is multifunctional. Preferably the (meth) acrylic monomer (M2) is chosen from a compound comprising at least two (meth) acrylic functions. The (meth) acrylic monomer (M2) can also be chosen from a mixture of at least two compounds (M2a) and (M2b) each respectively comprising at least two (meth) acrylic functions.

The (meth) acrylic monomer (M2) can be chosen from 1,3-butylene glycol dimethacrylate; 1,4-butanediol dimethacrylate; 1,6 hexanediol diacrylate; 1,6 hexanediol dimethacrylate; diethylene glycol dimethacrylate; dipropylene glycol diacrylate; ethoxylated (10) bisphenol a diacrylate; ethoxylated (2) bisphenol a dimethacrylate; ethoxylated (3) bisphenol a diacrylate; ethoxylated (3) bisphenol a dimethacrylate; ethoxylated (4) bisphenol a diacrylate; ethoxylated (4) bisphenol a dimethacrylate; ethoxylated bisphenol a dimethacrylate; ethoxylated (10) bisphenol dimethacrylate; ethylene glycol dimethacrylate; polyethylene glycol (200) diacrylate; polyethylene glycol (400) diacrylate; polyethylene glycol (400) dimethacrylate; polyethylene glycol (400) dimethacrylate; polyethylene glycol (600) diacrylate; polyethylene glycol (600) dimethacrylate; polyethylene glycol 400 diacrylate; propoxylated (2) neopentyl glycol diacrylate; tetraethylene glycol diacrylate; tetraethylene glycol dimethacrylate; tricyclodecane dimethanol diacrylate; tricyclodecanedimethanol dimethacrylate; triethylene glycol diacrylate; triethylene glycol dimethacrylate; tripropylene glycol diacrylate; ethoxylated (15) trimethylolpropane triacrylate; ethoxylated (3) trimethylolpropane triacrylate; ethoxylated (6) trimethylolpropane triacrylate; ethoxylated (9) trimethylolpropane triacrylate; ethoxylated 5 pentaerythritol triacrylate; ethoxylated (20) trimethylolpropane triacrylate; propoxylated (3) glyceryl triacrylate; trimethylolpropane triacrylate; propoxylated (5.5) glyceryl triacrylate; pentaerythritol triacrylate; propoxylated (3) glyceryl triacrylate; propoxylated (3) trimethylolpropane triacrylate; trimethylolpropane triacrylate; trimethylolpropane trimethacrylate; tris(2-hydroxy ethyl) isocyanurate triacrylate; di-trimethylolpropane tetraacrylate; ethoxylated (4) pentaerythritol dipentaerythritol pentaacrylate; tetraacrylate; pentaerythritol tetraacrylate; dipentaerythritol hexaacrylate; 1,10 decanediol diacrylate; 1,3-butylene glycol diacrylate; 1,4-butanediol diacrylate; 1,9-nonanediol diacrylate; 2-(2-Vinyloxyethoxy)ethyl acrylate; 2-butyl-2-ethyl-1,3-propanediol diacrylate; 2-methyl-1,3-propanediol diacrylate; 2-methyl-1,3-propanediyl ethoxy acrylate; 3 methyl 1,5-pentanediol diacrylate; alkoxylated cyclohexane dimethanol diacrylate; alkoxylated hexanediol diacrylate; cyclohexane dimethanol diacrylate; ethoxylated cyclohexane dimethanol diacrylate; diethyleneglycol diacrylate; dioxane glycol diacrylate; ethoxylated dipentaerythritol hexaacrylate; ethoxylated glycerol triacrylate; ethoxylated neopentyl glycol diacrylate; hydroxypivalyl hydroxypivalate diacrylate; neopentyl glycol diacrylate; poly (tetramethylene glycol) diacrylate; polypropylene glycol 400 diacrylate; polypropylene glycol 700 diacrylate; propoxylated (6) ethoxylated bisphenol A diacrylate; propoxylated ethylene glycol diacrylate; propoxylated (5) pentaerythritol tetraacrylate; and propoxylated trimethylol propane triacrylate.

Preferably the (meth) acrylic monomer (M2) is chosen from ethylene glycol dimethacrylate, neopentyl glycol diacrylate, neopentyl glycol dimethacrylate, 1,4-butanediol dimethacrylate, 1,4-butanediol diacrylate, 1,3-butylene glucol diacrylate, 1,3-butylene glycol dimethacrylate, triethylene glycol dimethacrylate, tricyclodecanedimethanol dimethacrylate and triethylene glycol diacrylate or mixtures thereof.

The (meth) acrylic monomer (M2) can be present in (meth) acrylic composition MCI between 0.01 and 10 phr by weight, preferably is present between 0.1 and 9.5 phr for 100 parts of a liquid (meth) acrylic syrup, more preferably between 0.1 and 9 phr, even more preferably between 0.1 and 8.5 phr and advantageously between 0.1 and 8 phr.

In a first more preferred embodiment, the (meth) acrylic monomer (M2) is present in (meth) acrylic composition MCI between 0.01 and 9 phr and is chosen from a compound comprising two (meth) acrylic functions.

In a second more preferred embodiment, the (meth) acrylic monomer (M2) is present in (meth) acrylic composition MCI between 0.01 and 9 phr and is chosen from a mixture of compounds comprising two (meth) acrylic functions.

In a third more preferred embodiment, the (meth) acrylic monomer (M2) is present in (meth) acrylic composition MCI between 0.01 and 9 phr and is chosen from a mixture of compounds comprising at least two (meth) acrylic functions.

In a fourth more preferred embodiment, the (meth) acrylic monomer (M2) is present in (meth) acrylic composition MCI between 0.01 and 9 phr and is chosen from a mixture of compounds comprising at least two (meth) acrylic functions. At least one compound of the mixture comprises only two (meth) acrylic functions and presents at least 50 wt % of the mixture of (meth) acrylic monomer (M2), preferably at least 60 wt %. The other compound of the mixture comprises more than two (meth) acrylic functions.

According to another embodiment of the step of wetting, the thermoplastic composition may be a polymer resin precursor. A polymer resin precursor is not fully polymerized. The composition of a polymer resin precursor comprises a polymerizable or curable component. In order to finish polymerization preferably an initiator is present or added.

An initiator (Ini) will be able to start the polymerization of the (meth) acrylic monomers (Ml) and (M2), and it is chosen from a radical initiator.

Preferably the initiator (Ini) is activated by heat.

The radical initiators (Ini) can be chosen from a peroxy group comprising compound or an azo group comprising compounds and preferably from a peroxy group comprising compound.

Preferably the peroxy group comprising compound comprises from 2 to 30 carbon atoms.

Preferably the peroxy group comprising compound is chosen from diacyl peroxides, peroxy esters, peroxydicarbonates, dialkyl peroxides, peroxyacetals, hydroperoxide or peroxyketale.

The initiator (Ini) is chosen from diisobutyryl peroxide, cumyl peroxyneodecanoate, di (3-methoxybutyl) peroxydicarbonate 1,1,3,3-Tetramethylbutyl peroxyneodecanoate, cumyl peroxyneoheptanoate, di-n-propyl peroxydicarbonate, tert-amyl peroxyneodecanoate, di-sec-butyl peroxydicarbonate, diisopropyl peroxydicarbonate, di (4-tert-butylcyclohexyl) peroxydicarbonate, di-(2-ethylhexyl)-peroxydicarbonate, tert-amyl peroxyneodecanoate, tert-butyl peroxyneodecanoate, di-n-butyl peroxydicarbonate, dicetyl peroxydicarbonate, dimyristyl peroxydicarbonate, 1,1,3,3-tetramethylbutylperoxypivalate, tert-butyl peroxyneoheptanoate, tert-amyl peroxypivalate, tert-butyl peroxypivalate, di-(3,5,5-trimethylhexanoyl)-peroxide, dilauroyl peroxide, didecanoyl peroxide, 2,5-dimethyl-2,5-di (2-ethylhexanoylperoxy)-hexane, 1,1,3,3-tetramethylbutyl peroxy-2-ethylhexanoate, tert-amyl peroxy-2-ethylhexanoate, dibenzoyl peroxide, tert-butyl peroxy-2-ethylhexanoate, tert-butyl peroxydiethylacetate, tert-butyl peroxyisobutyrate, 1,1-di-(tert-butylperoxy)-3,3,5-trimethylcyclohexane, 1,1-di (tert-amylperoxy)cyclohexane, 1,1-di-(tert-butylperoxy)-cyclohexane, tert-amyl peroxy-2-ethylhexylcarbonate, tert-amyl peroxyacetate, tert-butyl peroxy-3,5,5-trimethylhexanoate, 2,2-di-(tert-butylperoxy)-butane, tert-butyl peroxyisopropylcarbonate, tert-butyl peroxy-2-ethylhexylcarbonate, tert-amyl peroxybenzoate, tert-butyl peroxyacetate, butyl 4,4-di (tert-butylperoxy) valerate, tert-butyl peroxybenzoate, di-tert-amylperoxide, dicumyl peroxide, di-(2-tert-butyl-peroxyisopropyl)-benzene, 2,5-dimethyl-2,5-di-(tert-butylperoxy)-hexane, tert-butylcumyl peroxide, 2,5-dimethyl-2,5-di (tert-butylperoxy) hexyne-3, di-tert-butyl peroxide, 3,6,9-triethyl-3,6,9-trimethyl-1,4,7-triperoxonane, 2,2′-azobis-isobutyronitrile (AIBN), 2,2′-azodi-(2-methylbutyronitrile), azobisisobutyramide, 2,2′-azobis(2,4-dimethylvaleronitrile), 1,1′-Azodi (hexahydrobenzonitrile), or 4,4′-azobis(4-cyanopentanoic) or mixtures thereof.

Preferably the initiator (Ini) is chosen from cumyl peroxyneodecanoate, di (3-methoxybutyl) peroxydicarbonate, 1, peroxyneodecanoate, cumyl 1,3,3-tetramethylbutyl peroxyneoheptanoate, di-n-propyl peroxydicarbonate, tert-amyl peroxyneodecanoate, di-sec-butyl peroxydicarbonate, diisopropyl peroxydicarbonate, di (4-tert-butylcyclohexyl) peroxydicarbonate, di-(2-ethylhexyl)-peroxydicarbonate, tert-amyl peroxyneodecanoate, tert-butyl peroxyneodecanoate, di-n-butyl peroxydicarbonate, dicetyl peroxydicarbonate, dimyristyl peroxydicarbonate, 1,1,3,3-tetramethylbutylperoxypivalate, tert-butyl peroxyneoheptanoate, tert-amyl peroxypivalate, tert-butyl peroxypivalate, di-(3,5,5-trimethylhexanoyl 1-peroxide, dilauroyl peroxide, didecanoyl peroxide, 2,5-dimethyl-2,5-di(2-ethylhexanoylperoxy)-hexane or 1,1,3,3-tetramethylbutyl peroxy-2-ethylhexanoate or mixtures thereof.

The thermoplastic composition may comprise between 0.1 phr and 5 phr of a initiator (Ini) to start the polymerization of the (meth) acrylic monomer (Ml) and (meth) acrylic comonomer (M2).

The method 100 according to the invention may comprise a step of heating 113. Preferably the step of heating is implemented by a heating device. The step of heating allows triggering and initiate the polymerization of the thermoplastic composition which has impregnated fibers.

The heating also allows to increase the space between the molecules, which allows to increase the flexibility of the thermoplastic composite. As explained thermoplastic composite has the specificity of being generally solid at room temperature and while softening during an increase in temperature, in particular after passing its glass transition temperature (Tg) or the melting temperature (Tf) and becoming solid again when the temperature drops below its melting point and below its glass transition temperatures. Preferably, the (meth) acrylic thermoplastic polymer, forming the (meth) acrylic thermoplastic polymer matrix, has a glass transition temperature (Tg) of between 50 °C and 160 °C, preferably between 70 °C and 140 °C, and even more preferably 90 °C and 120 °C. This aspect gives it an advantage over other thermoplastic polymers such as polyamines. Indeed, polyamines generally have very high melting points, namely from 200 °C and higher, which does not facilitate the process. Glass transition temperatures or melting points can be measured by methods well known to those skilled in the art. Preferably, these temperatures are measured by Differential Scanning calorimetry according to the conditions specified in standards ISO 11357-2/2013 for Tg and ISO 11357-3/2011 for Tm. In addition, the (meth) acrylic thermoplastic polymer or a portion of the (meth) acrylic thermoplastic polymer has a melt flow index (MFI) according to ISO 1133 (230 °C/3.8 kg) of less than 20 g/10 min. Preferably, the melt flow index is less than 18 g/10 min, more preferably less than 16 g/10 min, advantageously less than 13 g/10 min.

The step of heating may comprise heating by convection, by conduction, by IR (infrared) (comprising NIR and MIR (near and mid infrared)), by microwave, by UV (ultraviolet) and/or by induction.

According to an embodiment of the step of heating 113, the polymerization may take place at a temperature typically below 140 °C, preferably below 130 °C and even more preferably below 125 °C.

According to an embodiment of the step of heating, the polymerization may take place at a temperature of at least 40 °C, preferably at least 50 °C and more preferably at least 60 °C.

Preferably the polymerization may take place at temperature between 40 °C and 140 °C, preferably between 50 °C and 130 °C, even more preferably between 60 °C and 125 °C.

Advantageously, the step of heating may be implemented continuously or not.

The heating step and the polymerization allow to pass from a thermoplastic composition which has impregnated the fibers (polymeric resin or a polymeric resin precursor) and which is liquid to a thermoplastic composite.

Preferably, the heated thermoplastic composite is not limited to its geometries.

Preferably, the heated thermoplastic composite is not limited to its dimension for example by its length.

Preferably the pultruded planks from thermoplastic composite are obtained from a pultrusion process and more preferably from a reactive pultrusion process. The pultrusion and the reactive pultrusion process are known by the skilled in the art. In these processes, the fibers are guided through a resin bath or an injection chamber comprising the composition or the syrup. The fibers as fibrous reinforcement are for example in a form of a unidirectional roving or a continuous filament mat. After impregnation in the resin, the wetted fibers are pulled through a heated device, where polymerization can take place.

Advantageously, the method 100 according to the invention may comprise a step of thermoforming. The pultruded planks may be shaped. A shape may be a bent, a curvature, a twisting, a folding, a compression, a complex shape, or a combination of any of the foregoing. According to an embodiment, the pultruded planks comprises a change of its form in at least one portion of the whole pultruded planks.

Preferably, the step of thermoforming is implemented by pulling the heated pultruded planks through a shaping device. The heated portion may be shaped with different geometry thank to the heated thermoplastic composite. The step of thermoforming allows to change the form of the pultruded planks. The thermoforming step may be realized thank to fixture tools, weight on either side of the thermoplastic composite, rotary motors or with a mold. The thermoforming step may comprise a pressure applied to the pultruded planks preferably to the heated pultruded planks.

The method according to the invention may comprise a step of cooling 114. In a particular embodiment, the step of cooling may be implemented by a cooling device. In addition, the step of cooling may be implemented at a given cooling temperature and/or for a given cooling duration. The step of cooling allows to switch from a heated composite (i.e. pultruded planks) to a cooled composite that is easier to handle.

According to an embodiment, the cooling temperature and/or the cooling duration may be selected in accordance with the glass transition temperatures (Tg) and/or the melting temperature of the heated thermoplastic composite. Preferably, the step of cooling is at a cooling temperature below to a glass transition temperature of the heated thermoplastic composite. For example, the Tg may be below 130 °C, preferably below 120 °C and more preferably below 110 °C.

The method according to the invention may comprise a step of pull out 116 the pultruded planks. In a particular embodiment, the step of pull out may be implemented manually or automatically. The step of pull out may be implemented by mechanical cutting to a length required.

The step of pull out allows to recover the pultruded planks.

The step of pull out may be implemented in order to the pultruded planks have a thickness from 2 mm to 8 mm, preferably from 3 mm to 7 mm more preferably from 4 mm to 6 mm.

Each pultruded plank may have a lower surface and an upper surface extending in a longitudinal direction. The upper surface and the lower surface may be defined as the two longest surfaces of the pultruded plank and the upper surface being opposite to the lower surface.

A pultruded plank may have different geometries such as, oval, flat, linear, circular. Preferably, the plurality of pultruded planks has the same geometry. More preferably, the pultruded plank may have a constant section.

The step of providing a plurality of pultruded planks according to the invention may comprise other optional steps. For example, the step of providing pultruded planks may comprise a step of surface texturization 115. This step allows to improve the roughness and consequently the adherence.

Preferably said textured surface may have a Ra between 3 μm and 30 μm according to the norm ISO 4287:1997. Advantageously, a surface of a pultruded plank can have a rough outer surface for more grip afterwards to better adhere to the wind turbine blade.

The textured surface may comprise channels with a depth of at least 0.04 mm and at most 0.5 mm.

The step of surface texturization may comprise texturing at least one surface (i.e. upper and/or lower) of the pultruded planks.

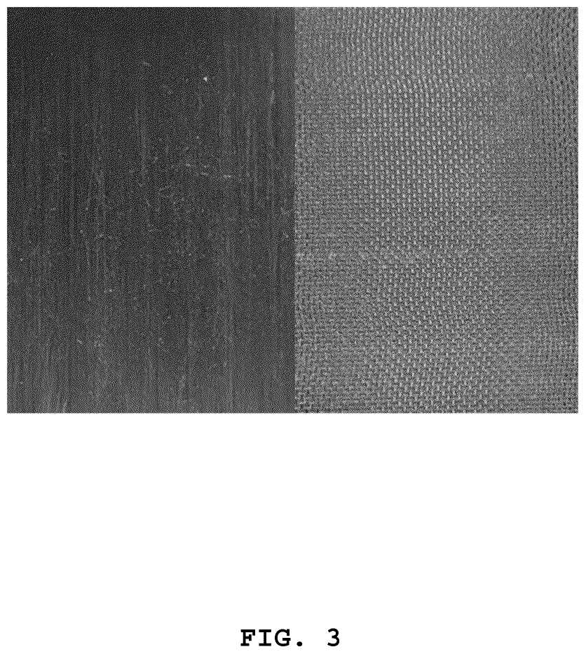

The step of surface texturizing may be selected among sandblasting, scraping, chemical pickling, lamination, and/or calendaring. Advantageously, the step of surface texturization doesn't comprise a peel-ply. More preferably, the pultruded planks do not comprise a peel-ply. Preferably the step of surface texturizing comprises a calendaring as illustrated in the FIG. 3. The advantage of the pultruded planks is its thermoplastic behaviour that notably allows designing a pattern. In addition, the calendaring allows to replace peel-ply that is expensive and slows down production. Advantageously, calendaring allows to design pattern, to increase the roughness and to be quick to implement.

Back to the FIG. 1 and according to an embodiment, the method according to the invention may comprise a step of providing 120 a plurality of interlayers.

The interlayers may comprise fibers, preferably glass fibers or carbon fibers. The fibers may correspond to the fibers as described above. The fibres in each interlayer may be stitched together, held together by binding agent, stitched and/or woven together.

The interlayers may be a tissue or fabric, preferably a glass fabric and more preferably a permeable glass fabric.

The interlayers may consist in a thermoplastic layer.

Preferably, the thermoplastic layer may be a thermoplastic composition. The thermoplastic composition may be a thermoplastic polymer and/or thermoplastic polymer alloy.

The thermoplastic layer may comprise at most 10% in volume of fibers, preferably at most 5%.

Preferably the interlayers may have the same dimension and/or geometry as the pultruded planks. Equally, each interlayer may have a lower surface and an upper surface extending in the longitudinal direction. The upper surface and the lower surface may be defined as the two longest surfaces of the interlayer and the upper surface being opposite to the lower surface.

According to an embodiment, the interlayers may have a thickness from 0.05 mm to 0.5 mm.

The method according to the invention may comprise a step of stacking 130 the pultruded planks into a pre-spar cap shape. Preferably, this step is conducted in a mold.

The step of stacking may comprise a thermoforming step.

According to an embodiment, an interlayer may be arranged between the lower surface and the upper surface of two pultruded planks, such as the upper or lower interlayer surface is facing the lower surface of a first pultruded plank and the upper or lower interlayer surface is facing the upper surface of a second pultruded plank.

Alternatively, pultruded planks may be separated by one or more interlayers.

The stacking step can be carried out until a required thickness is reached, preferably according to the thickness of the expected spar cap. Preferably, the maximum strain is less than the breaking strain of the fiber and more preferably for a carbon fiber is 1.8% or less. The thickness may be calculated in this regard.

According to an embodiment, the stacking step may comprise at least two pultruded planks.

According to another embodiment, the stacking step may comprise at least one interlayer between two pultruded planks.

The method according to the invention may comprise a step of joining 140 the stacked pultruded planks. This step allows to form and finally produce a spar-cap. According to an embodiment, a pre-spar-cap shape may be joined in a spar-cap.

The step of joining may be conducted in a spar cap mold. This mold may be the same that the mold for stacking the pultruded planks.

Alternatively, the staked pultruded planks of the spar cap are joined in a spar cap mold, and the spar cap will be joined in the rotor blade for example with a rotor blade mold.

According to an embodiment, the joining 140 step may be conducted in a rotor blade mold.

According to an embodiment, the staked pultruded planks of the spar cap are joined at the time of the formation of the rotor blade, preferably through infusion and/or thermoplastic adhesive.

The joining 140 step may comprise plastic joining, plastic welding, infusion and preferably thermoplastic infusion, ultrasonic welding, induction welding, resistance wire welding, laser welding, heating by infrared or ultraviolet radiation, and/or gluing. The plastic welding may comprise heating. The heating may be selected among conduction heating, radial heating and/or volumetric heating. Preferably the joining step may comprise welding. Indeed, the thermoplastic spar cap can be welded instead of using adhesive that allows the production of a easily recyclable spar cap and consequently rotor blade turbine that does not need any material separation. Preferably, the weld-type interface may have a thickness of greater than or equal to 0.05 mm, preferably greater than or equal to 0.5 mm. The thickness of the weld-type interface may be measured by conventional methods, for example from a vertical section of said weld-type interface.

The method may also comprise a step of infusion. The joining 140 step may comprise infusing a polymeric resin between the pultruded planks and curing the polymeric resin in order to form the spar cap. The joining 140 step may comprise infusing a polymeric resin between the pultruded planks and curing the polymeric resin in order to form the spar cap for example at the time of the formation of the rotor blade.

The joining 140 step may comprise applying at least one deforming force to the spar cap. Applying a deformation to the spar-cap can make it possible to take the shape of the mold and match the shape of a wind turbine blade. Deformation can be applied thanks to the heat by a force, a sub-vacuum force, a weight and/or a mold.

The method for producing a spar cap according to the invention may further comprise a thermoforming 150 step. The thermoforming 150 step may correspond to the thermoforming step as disclosed above.

The method according to the invention is faster and energy saving production compared to conventional thermoplastic pultrusion by using notably reactive pultrusion. In addition, as shown, the method allows producing spar caps that have same (or better) properties as thermoset spar cap.

The method leaves free to replace peel-ply use that is expensive and slows down production by calendaring at least one surface of the pultruded plank for improving the surface roughness. The method also leaves free to weld the complete spar cap.

In addition, the method allows the production of a recyclable spar cap and wind blade.

Finally, the method according to the invention allows to reduce waste, time and cost while meeting the needs and requirements of the sector.

According to another aspect, the invention proposes a spar cap for wind turbine obtainable, preferably obtained, by a method according to the invention.

A spar cap for wind turbine may comprise a plurality of joined pultruded planks, said pultruded planks being a thermoplastic composite, said thermoplastic composite comprising 45% or less in volume of a polymeric matrix including (meth)acrylic polymers, and at least 55% in volume of fibers. Preferably the thermoplastic composite comprises 40% or less in volume of a polymeric matrix including (meth)acrylic polymers, and at least 60% in volume of fibers, and even more preferably the thermoplastic composite comprises 35% or less in volume of a polymeric matrix including (meth)acrylic polymers, and at least 65% in volume of fibers. The pultruded planks are a thermoplastic composite comprising at least 25% in volume of a polymeric matrix including (meth)acrylic polymers, and at most 75% in volume of fibers. Preferably the thermoplastic composite comprises at least 27% in volume of a polymeric matrix including (meth)acrylic polymers, and at most 73% in volume of fibers. More preferably, the thermoplastic composite comprises at least 30% in volume of a polymeric matrix including (meth)acrylic polymers, and at most 70% in volume of fibers. The pultruded planks are a thermoplastic composite comprising between 25% and 45% in volume of a polymeric matrix including (meth)acrylic polymers, and between 55% and 75% in volume of fibers. Preferably, the thermoplastic composite comprises between 27% and 40% in volume of a polymeric matrix including (meth)acrylic polymers, and between 60% and 73% in volume of fibers. More preferably, the thermoplastic composite comprises between 30% and 35% in volume of a polymeric matrix including (meth)acrylic polymers, and between 65% and 70% in volume of fibers.

The fiber and resin content is measured according to ISO 1172:1996 when the fibers are glass fibers and according to ISO 14127:2008 when the fibers are carbon fibers. With the density of the respective materials, the % in volume can be transferred to % by weight and vice versa.

According to an embodiment, said pultruded planks may have at least one textured surface. The textured surface may have a Ra between 3 μm and 30 μm according to the norm ISO 4287:1997.

The pultruded planks may be separated by one or more interlayers. The spar cap according to the invention may comprise interlayers as disclosed above.

Preferably, the spar cap according to the invention doesn't comprise thermoset.

Preferably, the spar cap according to the invention doesn't comprise peel-ply.

The spar cap for wind turbine according to the invention is easily recyclable. In addition, the spar cap according to the invention is high strength and lightweight. It also presents a very good UV resistance and impact resistance.

The spar cap according to the invention is also easily thermoforming, bonding, welding and/or over molding.

Spar caps according to the invention present similar mechanical properties compared to thermoset resins. In addition, spar caps according to the invention meet the specifications required in the field.

According to another aspect, the invention relates to a rotor blade comprising a spar cap according to the invention.

A rotor blade may comprise a cross-sectional form that changes between a tip and a root of the rotor blade, corresponding to an attachment zone. The rotor blade may comprise an outer casing defining a lower surface and an upper surface and a leading edge and a trailing edge. The outer casing is for example more particularly formed with a spar cap.

Preferably the spar cap extends along the wind turbine blade and between at least the leading edge and/or at least the trailing edge. The spar cap allows to improve the stability and local stiffness compared to rotor blade of thermoplastic polymer composite alone.

The present invention based on the use of thermoplastic polymer composite makes it possible to produce new rotor blade. Rotor blade according to the invention is easily recyclable and more recyclable compared to current rotor blade. In addition, the rotor blade according to the invention present similar mechanical properties compared to current rotor blade and more particularly to thermoset rotor blade and thermoset-thermoplastic rotor blade.

According to another aspect, the present invention relates to a method for producing a rotor blade comprising a spar cap according to the invention. The method may comprise a step of associating the spar cap with a shell and a shear web. The method may also comprise a step of joining them through gluing, welding or infusion.

Regarding the step of associating, different processes can be used. Mention may be made of vacuum-assisted resin infusion (VARI), vacuum-assisted resin molding transfer (VARTM), pultrusion, vacuum infusion molding, pressurized infusion molding, autoclave molding, resin transfer (RTM) molding and variants thereof such as (HP-RTM, C-RTM, I-RTM), reaction-injection molding (RIM), reinforced reaction-injection molding (R-RIM) and variants thereof, press molding, compression molding, liquid compression molding (LCM) or sheet molding (SMC) or bulk molding (BMC). Preferably, the rotor blade made of polymer composite is manufactured by low-pressure injection molding, infusion molding or by molding of (meth) acrylic thermoplastic polymer composite.

A first preferred manufacturing process for manufacturing wind turbine blade is a process according to which the thermoplastic composition is transferred onto the fibrous reinforcement by impregnation of the fibrous reinforcement in a mold.

A second preferred manufacturing process for manufacturing wind turbine blade are processes according to which the thermoplastic composition is used in the pultrusion process. The fibers are guided via a batch or in an injection chamber of thermoplastic composition comprising the composition according to the invention. The fibers in the form of fibrous reinforcement are, for example, in the form of a unidirectional roving or a continuous filament mat. After impregnation, the wet fibers are pulled through a heated die, where the polymerization occurs.

A third preferred manufacturing process is vacuum-assisted resin infusion (VARI).

The method for producing a rotor blade may further comprise a subsequent treatment with the aim of strengthening the outer casing and improving the mechanical and chemical properties thereof. The treatment may for example be specifically located in certain areas of the outer surface of the rotor blade, such as along the leading edge. In this case, the treatment may comprise the deposition of a protective layer of plastic or metal covering the leading edge.

The method for producing a rotor blade may further comprise a step of post-forming. Post-forming involves bending and also modifying the shape of the composite part. The process for manufacturing rotor blade may further comprise a step of rolling.

According to another aspect, the invention proposes a wind turbine comprising a spar cap according to the invention and/or or a rotor blade according to the invention.

The wind turbine according to the invention presents the same advantages as the spar cap according to the invention and/or the rotor blade according to the invention. Indeed, a wind turbine according to the invention is easily recyclable, while offering mechanical and chemical properties that meet the requirements of the wind industry.

### Example

A pultruded plank is prepared by pultrusion. Carbon fibers (SIGRAFIL® CT50-4.0/240) in pultrusion process are impregnated with a thermoplastic composition. The thermoplastic composition is a (meth)acrylic syrup S1. Syrup S1 is prepared by dissolving 20 parts by weight of the PMMA (BS520 a copolymer of MMA comprising ethyl acrylate as a comonomer) in 80 parts by weight of methyl with methacrylate, which is stabilized MEHQ (hydroquinone monomethyl ether) adding 2 parts by weight of 1,4-butanediol dimethacrylate and a mixture of three different initiators (Ini1), (Ini2) and (Ini3) of each 1 parts by weight: respectively di(4-tert-butylcyclohexyl) peroxydicarbonate (P16—Perkadox® 16 from the company Akzo Nobel), didecanoyl peroxide (DEC-Luperox® DEC from the company Arkema) and 2,5-dimethyl-2,5-di(2-ethylhexanoyl peroxy)hexane (Tx141—Trigonox® 141 from the company Akzo Nobel).

The impregnated fibers are heated to 110 °C during the pultrusion process in order to polymerize the thermoplastic composition. The pultrusion die is configured in order to obtain planks with a thickness of 5 mm and a width of 100 mm. The planks have following properties summarized in table 1.

TABLE 1
Properties following specification of one pultruded
plank of spar-cap of wind turbine.

| | | General Specification |
|---|---|---|
| Properties | Invention | Pultrusion for Spar cap |
| Flexural Strength 0° | 1200 | 900-1200 |
| (MPa) | | |
| Flexural Modulus 0° | 140 | 130-150 |
| (GPa) | | |
| Flexural Strain 0° | 0.9 | 0.9-1.1 |
| (%) | | |
| Flexural Strength | 82 | 20-100 |
| 90° (MPa) | | |
| ILSS 0° (MPa) | 55 | 50-80 |
| Tensile Strength 0° | 1850 | 1700-1900 |
| (MPa) | | |
| Tensile Modulus 0° | 156 | 130-160 |
| (GPa) | | |
| Tensile Strain 0° | 1.2 | 0.9-1.2 |
| (%) | | |
| Compressive Strength | 840 | 800-1200 |
| 0° (MPa) | | |
| Compressive Modulus | 140 | 130-160 |
| 0° (GPa) | | |
| Compressive Strain | 0.6 | 0.6-1.1 |
| (%) | | |
| Tensile-compressive | 150 | 130-160 |
| average modulus | | |
| Glass Transition T_{g} | 120 | 65-120 |
| by DMA (°C) | | |
| Degree of cure (%) | 99.6 | >98 |
| Fiber Content (vol %) | 69.6 | 60-72 |

The invention allows to propose spar cap comprising thermoplastics, preferably without thermoset and therefore easily recyclable, while offering mechanical and chemical properties that meet the requirements of the wind industry.

The invention allows to provide a recyclable solution for spar cap and preferably for pultruded spar cap and consequently for rotor blade and wind turbine. Each pultruded plank does not need to be glued to one another. In addition, a thermoplastic spar cap presents similar mechanical properties compared to thermoset resins and consequently for the rotor blade and wind turbine.

In addition, the invention allows to reduce waste and to facilitate the pultrusion process.

Furthermore, thanks to the thermoplastic behavior it is possible to design pattern directly without using peel-ply for example.

The invention also allows to save time and to reduce cycle times and cost.

The invention can be the subject of numerous variants and applications other than those described above. In particular, unless otherwise indicated, the different structural and functional characteristics of each of the implementations described above should not be considered as combined and/or closely and/or inextricably linked to each other, but on the contrary as simple juxtapositions. In addition, the structural and/or functional characteristics of the various embodiments described above may be the subject in whole or in part of any different juxtaposition or any different combination.

1. Method for producing a spar cap for a rotor blade of a wind turbine, said method comprising the steps of:
Providing a plurality of pultruded planks, said pultruded planks being a thermoplastic composite comprising 45% or less in volume of a polymeric matrix including (meth)acrylic polymers, and at least 55% in volume of fibers, preferably carbon fibers;
Stacking the pultruded planks into a pre-spar cap shape; and
Joining the staked pultruded planks in order to produce the spar cap.

2. Method for producing a spar cap according to claim 1, wherein the said pultruded planks being a thermoplastic composite comprising 35% or less in volume of a polymeric matrix including (meth)acrylic polymers, and at least 65% in volume of fibers.

3. Method for producing a spar cap according to claim 1, wherein the said pultruded planks being a thermoplastic composite comprising at least 25% in volume of a polymeric matrix including (meth)acrylic polymers, and at most 75% in volume of fibers.

4. Method for producing a spar cap according to claim 1, wherein the pultruded planks are a thermoplastic composite comprising between 25% and 45% in volume of a polymeric matrix including (meth)acrylic polymers, and between 55% and 75% in volume of fibers.

5. Method for producing a spar cap according to claim 1, wherein the pultruded planks are a thermoplastic composite comprising between 30% and 35% in volume of a polymeric matrix including (meth)acrylic polymers, and between 65% and 70% in volume of fibers.

6. Method for producing a spar cap according to claim 1, wherein the step of providing a plurality of pultruded planks comprises a step of surface texturization preferably said textured surface has a Ra between 3 μm and 30 μm according to the norm ISO 4287:1997.

7. Method for producing a spar cap according to claim 1, wherein the pultruded planks have thickness from 2 mm to 8 mm.

8. Method for producing a spar cap according to claim 1, wherein it further comprises a step for providing a plurality of interlayers.

9. Method for producing a spar cap according to claim 1, wherein said stacking step further comprises a thermoforming step.

10. Method for producing a spar cap according to claim 1, wherein the joining step is conducted in a spar cap mold.

11. Method for producing a spar cap according to claim 1, wherein the joining step is conducted in a rotor blade mold, and wherein the staked pultruded planks of the spar cap are joined at the time of the formation of the rotor blade, preferably through infusion, and/or thermoplastic adhesive.

12. Method for producing a spar cap according to claim 1, wherein the step of providing a plurality of pultruded planks comprises the following steps:
Provide roving fibers;
Impregnating the fibers with a polymeric resin comprising a polymeric matrix including acrylic polymers;
Heating the impregnated fibers;
Cooling the heated composite with optional calendaring; and
Pull out the pultruded planks.

13. Method for producing a spar cap according to claim 12, wherein the temperature during the heating step is between 40 °C and 140 °C.

14. Method for producing a spar cap according to claim 1, wherein the method comprises a step of surface texturization-1.

15. Method for producing a spar cap according to claim 1, wherein the pultruded planks do not comprise a peel-ply.

16. Method for producing a spar cap according to according to claim 1, wherein the fibers are glass fibers.

17. Method for producing a spar cap according to according to claim 1, wherein the fibers are carbon fibers.

18. A spar cap for wind turbine obtainable by a method according to claim 1.

19. A spar cap according to the claim 18, wherein it comprises a plurality of pultruded planks, said pultruded planks being a thermoplastic composite comprising 45% or less in volume of a polymeric matrix including (meth)acrylic polymers, and at least 55% in volume of fibers, preferably carbon fibers, a plurality may correspond to at least two.

20. A spar cap according to the claim 19, wherein the pultruded planks have at least one textured surface has a Ra between 3 μm and 30 μm according to the norm ISO 4287:1997.

21. A spar cap according to the claim 19, wherein the pultruded planks may be separated by one or more interlayers.

22. A rotor blade comprising a spar cap according to the claim 18.

23. A wind turbine comprising a spar cap according to claim 18.

24. A method for producing a rotor blade comprising a spar cap according to the claim 18, said method comprising associating the spar cap with a shell and a shear web and joining them through gluing, welding or infusion.
